(19) United States
(12) Patent Application Publication
(10) Pub. No.: US 2026/0234936 A1
(43) Pub. Date: Aug. 13, 2026

(54) MAINTENANCE ACCESS SYSTEMS FOR DRAINAGE SYSTEMS FOR AMENITIES PLANTERS

(71) Applicant: Trever Davis, Brandenton, FL (US)

(72) Inventor: Trever Davis, Brandenton, FL (US)

(21) Appl. No.: 19/051,543

(22) Filed: Feb. 12, 2025

(51) Int. Cl. E04D 13/04; A01G 9/033; A01G 9/28

(52) U.S. Cl. CPC E04D 13/0409; A01G 9/033; A01G 9/28; E04D 2013/0413

(57) ABSTRACT

A maintenance access system includes a pipe forming a cylindrical conduit extending from a first end to a second end and forming a hollow interior portion. The first end is connected to a surface of a building, the surface of the building defining a plane that is substantially parallel to a horizontal reference plane defined by the Earth’s surface. The pipe has a plurality of drainage holes extending from an exterior of the pipe into the hollow interior portion. A drainage pipe of an amenity planter drainage system extends substantially vertically from the surface of the building partially into the hollow interior portion of the pipe. The maintenance access system further includes a filter fabric extending from the second end to the first end and being external to the pipe. The maintenance access system further includes a cap removably affixed to the second end of the pipe.

### BACKGROUND

Embodiments described herein generally relate to drainage systems, and more specifically, to maintenance access systems for drainage systems for amenities planters.

Amenities planters are decorative and/or functional areas or containers integrated into building designs or landscapes, often used to enhance spaces, like rooftop terraces, plazas, or common areas, by incorporating greenery or serving as dividers and aesthetic elements. Amenities planters (or simply “planters”) can be integrated into roofs, decks, and other building structures to serve functional and/or aesthetic purposes. Planters enhance the utility of a building while contributing to its sustainability and visual appeal.

Green roofs are a common application where planters or layers of soil and vegetation are incorporated into roof structures. These roofs provide natural insulation, helping to reduce heating and cooling costs. They also manage stormwater by absorbing rainwater, reducing runoff and the strain on urban drainage systems.

Decks and terraces often feature built-in or freestanding planter boxes, which are designed to hold various types of plants. These planters provide privacy by serving as natural screens with tall or dense vegetation. They also enhance the aesthetic appeal of outdoor spaces, offering a way to incorporate greenery or flowers.

Planters can also be integrated as architectural features, such as in walls, ledges, or building façades.

### SUMMARY

According to an embodiment, a maintenance access system for an amenity planter drainage system is provided. The maintenance access system includes a pipe forming a cylindrical conduit extending from a first end to a second end and forming a hollow interior portion. The pipe is defined by at least one diameter and a length. The first end of the pipe is connected to a surface of a building, the surface of the building defining a plane that is substantially parallel to a horizontal reference plane defined by the Earth’s surface. The pipe has a plurality of drainage holes extending from an exterior of the pipe into the hollow interior portion. A drainage pipe of the amenity planter drainage system extends substantially vertically from the surface of the building partially into the hollow interior portion of the pipe. The maintenance access system further includes a filter fabric extending from the second end of the pipe to the first end of the pipe and being external to the pipe. The maintenance access system further includes a cap removably affixed to the second end of the pipe.

In addition to one or more of the features described herein, or as an alternative, further embodiments of the maintenance access system may include that the first end is connected to the surface of the building by embedding at least a portion of the pipe extending from the first end into a recess formed in the surface of the building such that the pipe is partially embedded in the building.

In addition to one or more of the features described herein, or as an alternative, further embodiments of the maintenance access system may include that water flows through the filter fabric, through at least one of the plurality of drainage holes, and into the drainage pipe of the amenity planter drainage system.

In addition to one or more of the features described herein, or as an alternative, further embodiments of the maintenance access system may include that the pipe is a corrugated pipe.

In addition to one or more of the features described herein, or as an alternative, further embodiments of the maintenance access system may include that the corrugated pipe is composed of a high-density polyethylene (HDPE).

In addition to one or more of the features described herein, or as an alternative, further embodiments of the maintenance access system may include that the filter fabric is secured to the second end of the pipe by the cap.

In addition to one or more of the features described herein, or as an alternative, further embodiments of the maintenance access system may include that the filter fabric extends at least partially into the hollow interior portion of the pipe.

According to another embodiment, embodiment an amenity planter drainage system is provided. The amenity planter drainage system includes a plurality of drainage pipes extending substantially vertically from a surface of a building, the surface of the building defining a plane that is substantially parallel to a horizontal reference plane defined by the Earth’s surface, the plurality of drainage pipes being fluidly connected. The amenity planter drainage system further includes a maintenance access system for each of the plurality of drainage pipes, each maintenance access system. The maintenance access system for each of the plurality of drainage pipes includes a pipe forming a cylindrical conduit extending from a first end to a second end and forming a hollow interior portion, the pipe by at least one diameter and a length. The first end of the pipe is connected to the surface of the building. The pipe has a plurality of drainage holes extending from an exterior of the pipe into the hollow interior portion. One of the plurality of drainage pipes of the amenity planter drainage system extends substantially vertically from the surface of the building partially into the hollow interior portion of the pipe. The maintenance access system for each of the plurality of drainage pipes further includes a filter fabric extending from the second end of the pipe to the first end of the pipe and being external to the pipe. The maintenance access system for each of the plurality of drainage pipes further includes a cap removably affixed to the second end of the pipe.

In addition to one or more of the features described herein, or as an alternative, further embodiments of the amenity planter drainage system may include that the first end is connected to the surface of the building by embedding at least a portion of the pipe extending from the first end into a recess formed in the surface of the building such that the pipe is partially embedded in the building.

In addition to one or more of the features described herein, or as an alternative, further embodiments of the amenity planter drainage system may include that water flows through the filter fabric, through at least one of the plurality of drainage holes, and into at least one of the plurality of drainage pipes of the amenity planter drainage system.

In addition to one or more of the features described herein, or as an alternative, further embodiments of the amenity planter drainage system may include that the pipe is a corrugated pipe.

In addition to one or more of the features described herein, or as an alternative, further embodiments of the amenity planter drainage system may include that the corrugated pipe is composed of a high-density polyethylene (HDPE).

In addition to one or more of the features described herein, or as an alternative, further embodiments of the amenity planter drainage system may include that the filter fabric is secured to the second end of the pipe by the cap.

In addition to one or more of the features described herein, or as an alternative, further embodiments of the amenity planter drainage system may include that the filter fabric extends at least partially into the hollow interior portion of the pipe.

According to yet another embodiment, a method is provided. The method includes positioning a pipe of a maintenance access system substantially vertically with respect to a drainage pipe extending substantially vertically from a surface of a building, the surface of the building defining a plane that is substantially parallel to a horizontal reference plane defined by the Earth’s surface. The pipe forms a cylindrical conduit extending between a first end of the pipe and a second end of the pipe and forming a hollow interior portion, the first end of the pipe being connected to the surface of the building. A surface of the pipe has a plurality of drainage holes along a length of the pipe to allow water flow into the hollow interior portion while preventing ingress of larger particulates. The method further includes wrapping a filter fabric around an exterior of the pipe, extending from the second end to the first end, to act as a barrier against soil, roots, and other particulates. The method further includes affixing a removable cap to the second end of the pipe to prevent debris from entering the hollow interior portion while allowing for easy removal during maintenance.

In addition to one or more of the features described herein, or as an alternative, further embodiments of the method may include removing the removable cap from the second end during inspections and cleaning, enabling access to the hollow interior portion.

In addition to one or more of the features described herein, or as an alternative, further embodiments of the method may include that the first end is connected to the surface of the building by embedding at least a portion of the pipe extending from the first end into a recess formed in the surface of the building such that the pipe is partially embedded in the building.

In addition to one or more of the features described herein, or as an alternative, further embodiments of the method may include that water flows through the filter fabric, through at least one of the plurality of drainage holes, and into the drainage pipe.

In addition to one or more of the features described herein, or as an alternative, further embodiments of the method may include that the pipe is a corrugated pipe, wherein the corrugated pipe is composed of a high-density polyethylene (HDPE).

In addition to one or more of the features described herein, or as an alternative, further embodiments of the method may include that the filter fabric is secured to the second end of the pipe by the removable cap, and wherein the filter fabric extends at least partially into the hollow interior portion of the pipe.

The above features and advantages, and other features and advantages, of the disclosure are readily apparent from the following detailed description when taken in connection with the accompanying drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of one or more embodiments described herein are apparent from the following detailed description taken in conjunction with the accompanying drawings in which:

FIG. 1 is a diagram illustrating a maintenance access system for an amenity planter drainage system in accordance with one or more embodiments;

FIG. 2 is a diagram illustrating the maintenance access system for an amenity planter drainage system in accordance with one or more embodiments;

FIG. 3 illustrates a top-down view of a hollow interior portion of the maintenance access system in accordance with one or more embodiments;

FIG. 4 illustrates a top-down view of the hollow interior portion of the maintenance access system in accordance with one or more embodiments;

FIG. 5 illustrates a top-down view of filter fabric encasing a pipe of the maintenance access system in accordance with one or more embodiments;

FIG. 6 illustrates a top-down view of a cap removably affixed to the maintenance access system in accordance with one or more embodiments;

FIG. 7 illustrates a building having multiple maintenance access systems in accordance with one or more embodiments;

FIG. 8 illustrates a top-down view of a cap removably affixed to the maintenance access system in accordance with one or more embodiments; and

FIG. 9 depicts a flow diagram of a method 900 for implementing a maintenance access system for an amenity planter drainage system according to one or more embodiments described herein.

The diagrams depicted herein are illustrative. There can be many variations to the diagram or the operations described therein without departing from the scope of the embodiments described herein. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

### DETAILED DESCRIPTION

One or more embodiments described herein provide maintenance access systems for amenities planters drainage systems.

Amenities planters can be integrated into roofs, decks, and other building structures to serve functional and/or aesthetic purposes. However, the success of implementing of such planters depends on whether attention is paid to practical considerations associated with the amenities planters. For example, proper drainage systems are used to prevent water pooling, which can damage the underlying structure of the building and can be harmful to plants or objects within the planters.

More particularly, proper drainage for amenities planters is desired to prevent water accumulation that could lead to flooding, structural damage, and costly repairs. However, existing amenity planter drainage systems are prone to clogs caused by root intrusion, soil accumulation, and mineral buildup. Moreover, such approaches typically lack accessible maintenance points for accessing components of the amenity planter drainage systems for performing service and maintenance. This lack of access often causes excavation or disruptive interventions within or around the planters for repairs and cleaning, which is labor-intensive and costly.

One or more embodiments described herein address these and other shortcomings by providing a drainage system for amenities planters that support observation and maintenance access to enable efficient, non-invasive drainage system maintenance. One or more embodiments prevents clogging and enables easy access to the drainage infrastructure, making such one or more embodiments highly suitable for long-term use on amenities decks, rooftop gardens, and similar applications.

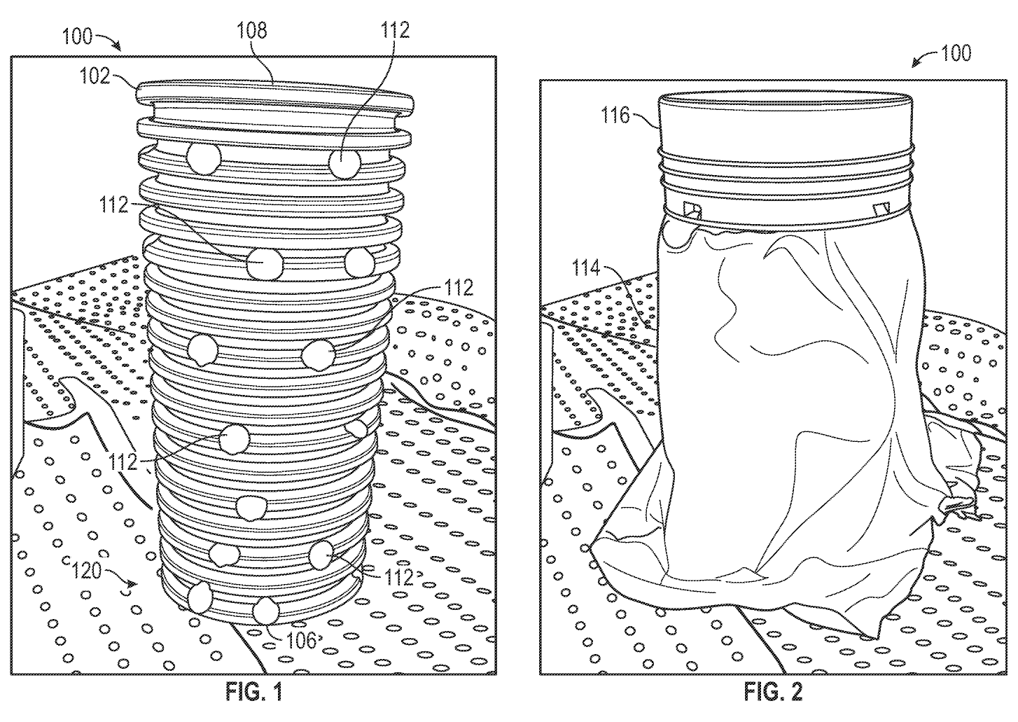

Various aspects of a maintenance access system 100 is now described in more detail with reference to FIGS. 1-8.

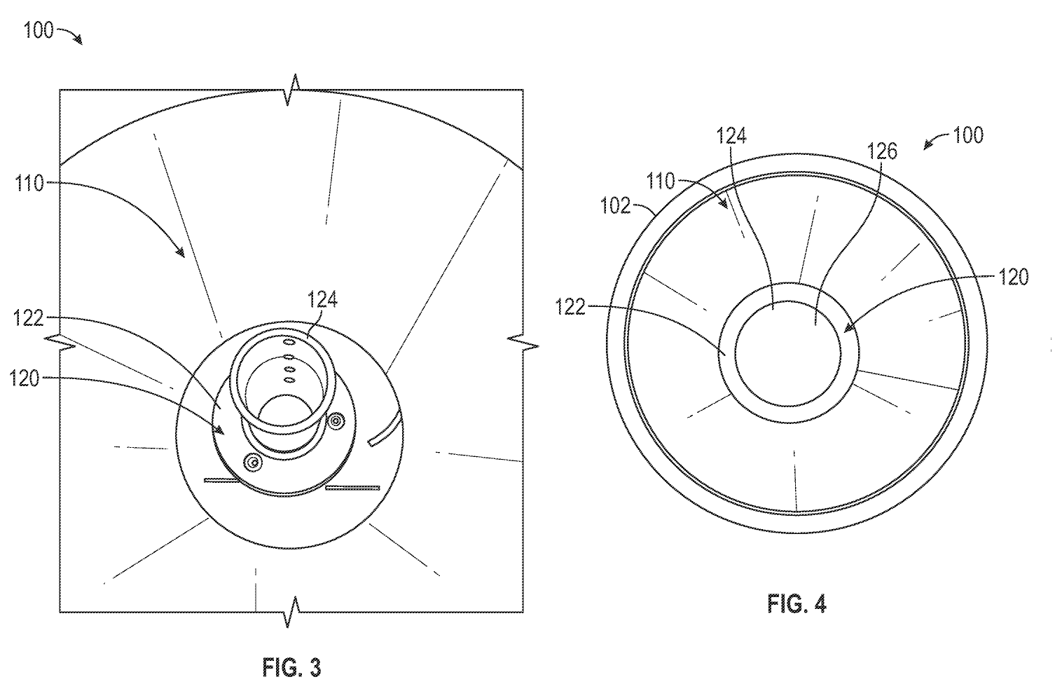

FIGS. 1 and 2 are diagrams illustrating a maintenance access system 100 for an amenity planter drainage system in accordance with one or more embodiments. The maintenance access system 100 includes a pipe 102 forming a cylindrical conduct extending from a first end 106 to a second end 108, a hollow interior portion (e.g., hollow interior portion 110 of FIGS. 3 and 4), drainage holes 112, a filter fabric 114, and a cap 116.

The pipe 102 is shown in FIG. 1, for example, where the pipe 102 is positioned substantially vertically with respect to a horizontal reference plane defined by the Earth’s surface. The pipe 102 forms a cylindrical conduit extending from a first end 106 to a second end 108, thereby forming a hollow interior portion. The pipe 102 is defined by at least one diameter and a length. The pipe 102 can be sized to accommodate various implementations. According to one or more embodiments, the diameter ranges between six and twelve inches, although other dimensions are possible in other embodiments. The length can vary in length in various implementations. The pipe 102 provides the necessary shape and support for the maintenance access system 100.

According to one or more embodiments, the pipe 102 is a corrugated pipe. According to one or more embodiments, the pipe 102 (e.g., a corrugated pipe) is formed of a high-density polyethylene (HDPE) or a similarly durable, flexible material, offering structural resilience and compatibility with environmental and soil conditions. According to one or more embodiments, the pipe 102 is formed of reinforced plastic, galvanized steel, or concrete, allowing the maintenance access system 100 to withstand harsh environmental conditions, including freeze-thaw cycles and high soil acidity or alkalinity.

The first end 106 of the pipe 102 is connected to a surface 122 of a building 120 (shown in FIGS. 3 and 4, for example). This connection ensures stability of the maintenance access system 100 and integration with the existing infrastructure (e.g., the building 120). According to one or more embodiments, the connection between the first end 106 of the pipe 102 and the building 120 is watertight or substantially watertight, whereby water and other liquids, including any solids, are restricted or prevented from passing through the connection. The second end 108 is open when uncapped, allowing for maintenance access, as depicted in FIGS. 1 and 4, for example.

The pipe 102 is designed to facilitate water flow through the drainage holes 112 into the hollow interior portion 110. The drainage holes 112 are distributed along the length of the pipe 102 from the first end 106 to the second end 108 and around its circumference. In particular, the drainage holes 112 are strategically positioned along the pipe 102 to enable water flow into the hollow interior portion 110 while preventing the ingress of larger particulates. The size and location of the drainage holes 112 can be selected based on desired performance of the maintenance access system 100. For example, more drainage holes and/or larger drainage holes can be used where relatively more water is desired to flow into the pipe 102, whereas relatively less drainage holes and/or smaller diameter holes can be used where relatively less water is desired to flow into the pipe 102. The drainage holes 112 are shown as having a substantially circular cross-section; however, it should be appreciated that other configurations are possible (e.g., ellipse, square, diamond, rectangle, etc.). The drainage holes 112 are useful for allowing water to enter the hollow interior portion 110 while blocking undesirable debris from entering the hollow interior portion 110.

According to one or more embodiments, the ingress of larger particulates, such as soil, plant roots, etc., into the hollow interior portion 110 is further reduced or prevented by using the filter fabric 114 in combination with the pipe 102. For example, the filter fabric 114 extends from the second end 108 to the first end 106 of the pipe 102 and is external to the pipe 102. The filter fabric 114 acts as a barrier against soil, roots, and other particulates. The filter fabric is shown in FIGS. 2, 5, and 6, enveloping the exterior of the pipe. According to one or more embodiments, the filter fabric 114 is constructed of a geotextile material resistant to ultraviolet light exposure and environmental degradation, ensuring long-lasting filtration performance. According to one or more embodiments, filter fabric can be substituted with denser geotextile fabric in areas with fine particulate soil or aggressive root growth to enhance filtration efficiency and clog prevention.

The hollow interior portion 110 is the internal space within the cylindrical conduit of the pipe 102 that allows for water flow, such as into a drainage pipe of an amenity planter drainage system. The hollow interior portion 110 is shown in FIGS. 3 and 4, where the drainage pipe 124 of the amenities planters drainage system extends into the hollow interior portion 110, facilitating efficient water management.

The cap 116 is removably affixed to the second end 108 of the pipe 102, providing a secure, but removable, closure that prevents debris from entering the hollow interior portion 110 while allowing for easy removal for maintenance, such as to clean out the hollow interior portion 110 or to service the drainage pipe 124 of the amenity planter drainage system. The cap 116 is depicted in FIGS. 2, 6, and 8, positioned at the top of the pipe 102 (e.g., at the second end 108). According to one or more embodiments, the cap 116 is useful for securing the filter fabric 114 to the pipe 102.

FIG. 2 illustrates the maintenance access system 100, focusing on the integration of the filter fabric 114 and the removable cap 116. This figure highlights the practical design elements that contribute to the effectiveness of the maintenance access system 100 in providing for access to aspects of amenities planters drainage systems. The filter fabric 114 is shown enveloping the exterior of the pipe 102, providing a barrier against soil, roots, and other particulates that could potentially clog the drainage system while allowing water and other fluids to flow though the filter fabric 114. The filter fabric 114 is secured in place, such as using the cap 116, ensuring durability and consistent performance under various environmental conditions. The removable cap 116 is positioned at the top of the pipe 102 (e.g., at the second end 108), designed to be easily detached for maintenance purposes. The cap 116 serves multiple functions: it prevents debris from entering the pipe, aids in securing the filter fabric 114, and enables straightforward access during routine inspections and cleaning. The figure underscores the user-friendly design of the maintenance access system 100, which facilitates maintenance access and enhances the overall longevity of amenities planters drainage systems. By incorporating these elements, the maintenance access system 100 effectively addresses common issues associated with traditional amenities planters drainage systems, offering a reliable and efficient approach for maintaining amenities planters drainage systems.

FIGS. 3 and 4 illustrate top-down views of the hollow interior portion 110 of the maintenance access system in accordance with one or more embodiments. In particular, these figures provide an internal view of the maintenance access system 100, focusing on the hollow interior portion 110 of the pipe 102. These figures highlight the integration of the drainage pipe 124 of the amenities planters drainage system, which extends substantially vertically from the surface 122 of the building 120 into the hollow interior portion 110. The arrangement ensures that water collected from the amenities planters is efficiently directed into the amenities planters drainage system, minimizing the risk of overflow or impairment from foreign objects (e.g., soil, plant roots, mulch, rocks, etc.). Further, this arrangement ensures that the amenities planters drainage system remains protected from debris while allowing for easy access during maintenance. As shown in FIG. 4, drainage pipe 124 is shown extending into the hollow interior portion 110. The drainage pipe 124 is capped by a drainage pipe cap 126.

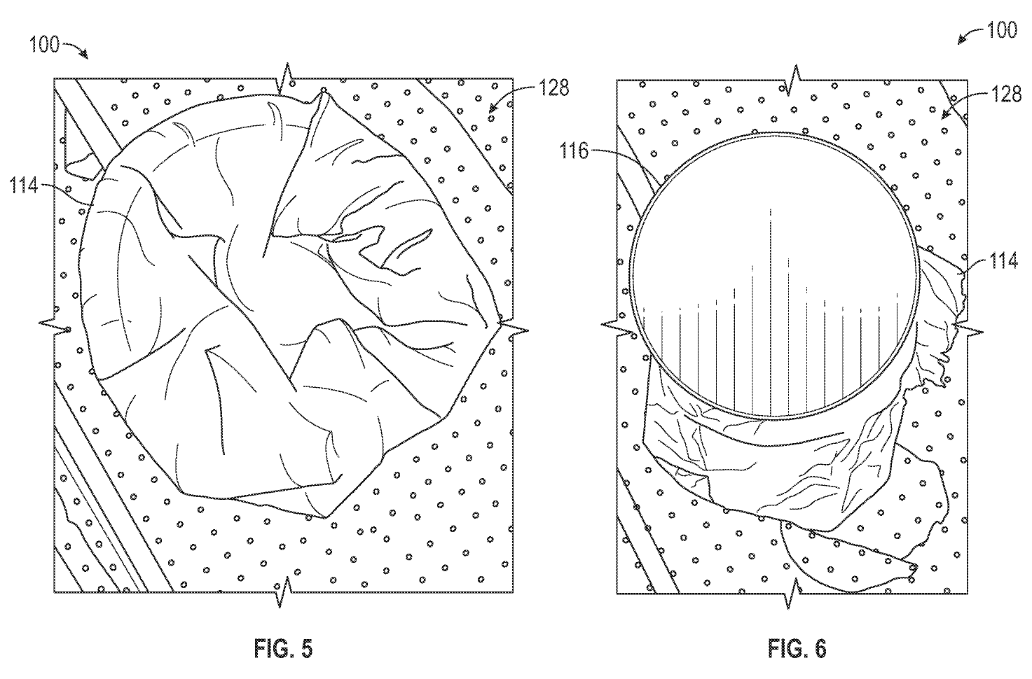

FIG. 5 illustrates a top-down view of the filter fabric 114 encasing the pipe of the maintenance access system 100 in accordance with one or more embodiments. The filter fabric 114 is depicted as a robust layer enveloping the pipe, providing a filtration function that prevents soil, plant root, and other debris ingress into the hollow interior portion 110. FIG. 5 also depicts a protective barrier 128 that is installed on the surface 122 of the building 120. According to one or more embodiments as described herein, the filter fabric 114 integrates with waterproofing layers of the surface 122 of the building 120 (e.g., the protective barrier 128), ensuring that water infiltration occurs solely within the drainage path, preventing leaks and structural water damage.

FIG. 6 illustrates a top-down view of the cap 116 removably affixed to the maintenance access system 100 in accordance with one or more embodiments. In this example, the cap 116 is in place over the filter fabric 114, thereby acting to hold the filter fabric 114 in place relative to the pipe 102. The cap 116 serves as a secure closure for the maintenance access system 100, preventing debris from entering while allowing for easy removal during maintenance. This figure highlights the system's user-friendly design, which facilitates straightforward access for inspections and cleaning.

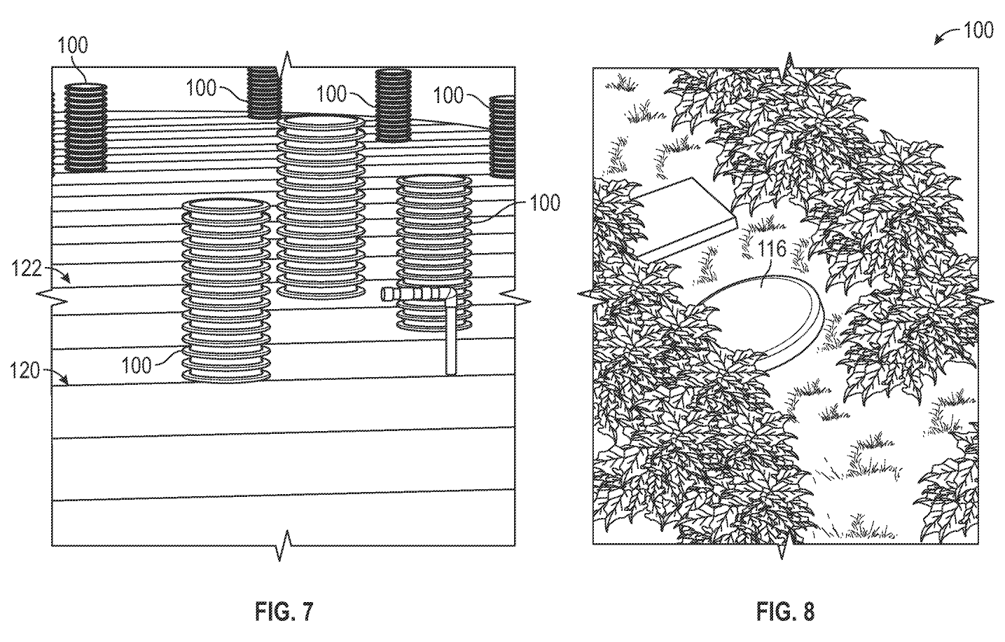

FIG. 7 illustrates a building having multiple maintenance access systems 100 in accordance with one or more embodiments. This figure provides a broader view of multiple maintenance access systems 100 installed across the surface 122 of the building 120. This figure demonstrates the scalability and adaptability of the maintenance access systems 100, showing how it can be deployed in various configurations to accommodate different drainage needs, multiple amenities planters, large amenities planters with multiple drain pipes (e.g., drainage pipe 124). The multiple maintenance access systems 100 are strategically positioned to manage water flow across the surface 122, ensuring efficient drainage and preventing water accumulation. This arrangement highlights the versatility and effectiveness of deploying multiple maintenance access systems 100 in large-scale applications, such as commercial or public spaces.

FIG. 8 illustrates a top-down view of a cap removably affixed to the maintenance access system 100 in accordance with one or more embodiments. In this figure, the maintenance access system 100 is shown in a completed landscaped setting (e.g., an amenities planter), with the cap 116 visible among the surrounding vegetation. This figure illustrates how the maintenance access system 100 is unobtrusive yet easily accessible in environments such as amenities planters, thereby maintaining the functionality of amenities planters drainage systems while blending with the aesthetic of the space. The cap 116 is shown substantially flush with the ground, minimizing visual disruption and tripping hazards. This configuration underscores the adaptability of the maintenance access system 100 to various settings, from urban rooftops to garden landscapes, providing reliable drainage solutions without compromising design.

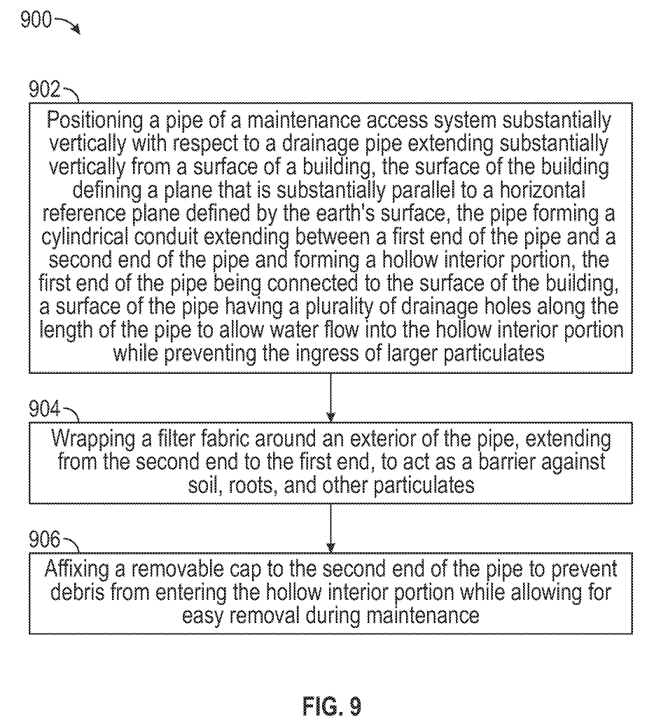

FIG. 9 depicts a flow diagram of a method 900 for implementing a maintenance access system for an amenity planter drainage system according to one or more embodiments described herein.

At operation 902, the method 900 includes positioning a pipe 102 of the maintenance access system 100 substantially vertically with respect to a drainage pipe 124. This drainage pipe 124 extends vertically from a surface 122 of a building 120, which defines a plane parallel to the Earth's horizontal reference plane. The pipe 102 forms a cylindrical conduit extending between a first end 106 and a second end 108, creating a hollow interior portion 110. The first end 106 of the pipe 102 is securely connected to the building's surface 122, ensuring stability and integration with the existing infrastructure of the building 120. A plurality of drainage holes 112 are disposed along the length of the pipe's surface. These holes are strategically positioned to allow water to flow into the hollow interior portion 110 while preventing the ingress of larger particulates, such as soil and roots, thereby maintaining efficient drainage.

Next, at operation 904, the method 900 involves wrapping a filter fabric 114 around the exterior of the pipe 102, extending from the second end 108 to the first end 106. The filter fabric 114 acts as a barrier against soil, roots, and other particulates, enhancing the clog prevention capabilities of the maintenance access system 100 and ensuring long-lasting filtration performance.

At operation 906, the method 900 includes affixing a removable cap (e.g., cap 116) is affixed to the second end 108 of the pipe 102. The cap 116 serves to prevent debris from entering the hollow interior portion 110 while allowing for easy removal during maintenance. The cap 116 facilitates straightforward access for routine inspections and cleaning, ensuring the amenity planter drainage system remains free of clogs and operates efficiently.

This method provides a comprehensive approach to maintaining the functionality and longevity of the amenity planter drainage system.

Additional processes also may be included, and it should be understood that the process depicted in FIG. 9 represents an illustration, and that other processes may be added or existing processes may be removed, modified, or rearranged without departing from the scope of the present disclosure.

The maintenance access system 100 for amenity planter drainage systems, as depicted in the figures, offers several benefits and technical improvements that enhance functionality and usability of amenity planter drainage systems, such as the following.

Non-Invasive Maintenance: The maintenance access system 100 enables easy access for inspection and maintenance without the need for excavation or disruptive interventions. The removable cap 116 facilitates straightforward access to the interior of the pipe 102, enabling routine cleaning and inspection. This reduces labor costs and minimizes disruption to the surrounding environment.

Clog Prevention: The inclusion of strategically positioned drainage holes 112 in the pipe 102 allows for efficient water flow while preventing the ingress of larger particulates such as soil and roots. The filter fabric 114 further enhances this by acting as a barrier against fine particulates and plant roots, ensuring that the amenity planter drainage system remains free of clogs and operates efficiently.

Durability and Adaptability: The maintenance access system 100 is constructed from durable materials, such as HDPE, which provide structural resilience and compatibility with various environmental conditions. This ensures long-term performance and adaptability to different planter configurations and climates.

Seamless Integration: The maintenance access system 100 is designed to integrate seamlessly with existing building infrastructure. The first end 106 of the pipe is connected to the surface 122 of the building 120, ensuring stability and alignment with the building’s amenity planter drainage system. This integration is highlighted in FIGS. 3 and 4, where the drainage pipe 124 of the amenity planter drainage system extends into the hollow interior portion 110 of the pipe 102.

Versatility: The modular design of the maintenance access system 100 allows it to be applied across a wide range of projects, from commercial high-rise decks to residential rooftop gardens and public green roofs. This versatility opens multiple revenue streams and market opportunities, particularly as urban spaces increasingly incorporate green infrastructure.

Aesthetic Considerations: The maintenance access system 100 is designed to blend with the surrounding environment, as shown in FIG. 8, where the cap 116 is substantially flush with the ground in a landscaped setting. This minimizes visual disruption and tripping hazards, making the maintenance access system 100 suitable for many environments.

Overall, the maintenance access system 100 provides a robust, forward-thinking solution to planter drainage management challenges, offering significant improvements over traditional methods.

Various embodiments are described herein with reference to the related drawings. Alternative embodiments can be devised without departing from the scope of the claims. Various connections and positional relationships (e.g., over, below, adjacent, etc.) are set forth between elements in the following description and in the drawings. These connections and/or positional relationships, unless specified otherwise, can be direct or indirect, and the embodiments described herein are not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ± 8% or 5%, or 2% of a given value.

The flowchart and block diagrams in the figures illustrate the architecture, functionality, and operation of possible implementations of systems, methods, and computer program products according to various embodiments described herein. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A maintenance access system for an amenity planter drainage system, the maintenance access system comprising:
a pipe forming a cylindrical conduit extending from a first end to a second end and forming a hollow interior portion, the pipe defined by at least one diameter and a length, wherein the first end of the pipe is connected to a surface of a building, the surface of the building defining a plane that is substantially parallel to a horizontal reference plane defined by the Earth’s surface, the pipe having a plurality of drainage holes extending from an exterior of the pipe into the hollow interior portion, a drainage pipe of the amenity planter drainage system extending substantially vertically from the surface of the building partially into the hollow interior portion of the pipe;
a filter fabric extending from the second end of the pipe to the first end of the pipe and being external to the pipe; and
a cap removably affixed to the second end of the pipe.

2. The maintenance access system of claim 1, wherein the first end is connected to the surface of the building by embedding at least a portion of the pipe extending from the first end into a recess formed in the surface of the building such that the pipe is partially embedded in the building.

3. The maintenance access system of claim 1, wherein water flows through the filter fabric, through at least one of the plurality of drainage holes, and into the drainage pipe of the amenity planter drainage system.

4. The maintenance access system of claim 1, wherein the pipe is a corrugated pipe.

5. The maintenance access system of claim 4, wherein the corrugated pipe is composed of a high-density polyethylene (HDPE).

6. The maintenance access system of claim 1, wherein the filter fabric is secured to the second end of the pipe by the cap.

7. The maintenance access system of claim 1, wherein the filter fabric extends at least partially into the hollow interior portion of the pipe.

8. An amenity planter drainage system comprising:
a plurality of drainage pipes extending substantially vertically from a surface of a building, the surface of the building defining a plane that is substantially parallel to a horizontal reference plane defined by the Earth’s surface, the plurality of drainage pipes being fluidly connected; and
a maintenance access system for each of the plurality of drainage pipes, each maintenance access system comprising:
a pipe forming a cylindrical conduit extending from a first end to a second end and forming a hollow interior portion, the pipe by at least one diameter and a length, wherein the first end of the pipe is connected to the surface of the building, the pipe having a plurality of drainage holes extending from an exterior of the pipe into the hollow interior portion, one of the plurality of drainage pipes of the amenity planter drainage system extending substantially vertically from the surface of the building partially into the hollow interior portion of the pipe;
a filter fabric extending from the second end of the pipe to the first end of the pipe and being external to the pipe; and
a cap removably affixed to the second end of the pipe.

9. The amenity planter drainage system of claim 8, wherein the first end is connected to the surface of the building by embedding at least a portion of the pipe extending from the first end into a recess formed in the surface of the building such that the pipe is partially embedded in the building.

10. The amenity planter drainage system of claim 8, wherein water flows through the filter fabric, through at least one of the plurality of drainage holes, and into at least one of the plurality of drainage pipes of the amenity planter drainage system.

11. The amenity planter drainage system of claim 8, wherein the pipe is a corrugated pipe.

12. The amenity planter drainage system of claim 11, wherein the corrugated pipe is composed of a high-density polyethylene (HDPE).

13. The amenity planter drainage system of claim 8, wherein the filter fabric is secured to the second end of the pipe by the cap.

14. The amenity planter drainage system of claim 8, wherein the filter fabric extends at least partially into the hollow interior portion of the pipe.

15. A method comprising:
positioning a pipe of a maintenance access system substantially vertically with respect to a drainage pipe extending substantially vertically from a surface of a building, the surface of the building defining a plane that is substantially parallel to a horizontal reference plane defined by the Earth’s surface, the pipe forming a cylindrical conduit extending between a first end of the pipe and a second end of the pipe and forming a hollow interior portion, the first end of the pipe being connected to the surface of the building, a surface of the pipe having a plurality of drainage holes along a length of the pipe to allow water flow into the hollow interior portion while preventing ingress of larger particulates;
wrapping a filter fabric around an exterior of the pipe, extending from the second end to the first end, to act as a barrier against soil, roots, and other particulates; and
affixing a removable cap to the second end of the pipe to prevent debris from entering the hollow interior portion while allowing for easy removal during maintenance.

16. The method of claim 15, further comprising removing the removable cap from the second end during inspections and cleaning, enabling access to the hollow interior portion.

17. The method of claim 15, wherein the first end is connected to the surface of the building by embedding at least a portion of the pipe extending from the first end into a recess formed in the surface of the building such that the pipe is partially embedded in the building.

18. The method of claim 15, wherein water flows through the filter fabric, through at least one of the plurality of drainage holes, and into the drainage pipe.

19. The method of claim 15, wherein the pipe is a corrugated pipe, wherein the corrugated pipe is composed of a high-density polyethylene (HDPE).

20. The method of claim 15, wherein the filter fabric is secured to the second end of the pipe by the removable cap, and wherein the filter fabric extends at least partially into the hollow interior portion of the pipe.
